(19) United States
(12) Patent Application Publication
(10) Pub. No.: US 2009/0277410 A1
(43) Pub. Date: Nov. 12, 2009

(54) SPARK PLUG

(75) Inventor: Hiroyuki Kameda, Aichi (JP)

Correspondence Address: KUSNER & JAFFE;HIGHLAND PLACE SUITE 310, 6151 WILSON MILLS ROAD, HIGHLAND HEIGHTS, OH, 44143, US

(73) Assignee: NGK SPARK PLUG CO., LTD., AICHI (JP)

(21) Appl. No.: 12/312,119

(22) PCT Filed: Feb. 25, 2008
(86) PCT No.: PCT/JP2008/053196

§ 371 Date: Apr. 27, 2009

(30) Foreign Application Priority Data
Mar. 26, 2007 (JP) 2007-078870

(51) Int. Cl. H01T 13/08

(52) U.S. Cl. 123/169 R

(57) ABSTRACT

Projecting portions extended in an axis (O) direction and projecting forward are formed on a front end face of a cylindrical portion provided on a front end side of a metal shell. The projecting portions are disposed at an equal interval therebetween in a circumferential direction revolving around a center S of a firing portion. Regardless of the mounting state of a spark plug on an engine head (i.e., a shift in the circumferential direction caused by a difference in tightening of a fitting screw), a side face or an end face of any one of projecting portions will face an upstream side of a fuel (combustible air-fuel mixture layer) flow direction, which flows with an air current in a combustion chamber. Therefore, the combustible air-fuel mixture layer colliding with the projecting portion includes the flow direction directed to the firing portion as its reflective direction and is thus adrift around the firing portion.

### FIELD OF THE INVENTION

The present invention relates to a spark plug for being mounted on an internal-combustion engine to ignite an air-fuel mixture.

### BACKGROUND OF THE INVENTION

Conventionally, a spark plug is used for ignition in an internal-combustion engine, such as a car engine. A common spark plug includes a center electrode, an insulator holding the center electrode in its bore and a metal shell radially surrounding and holding a circumference of the insulator. Further, the common spark plug has a ground electrode electrically connected to the metal shell. The ground electrode has one end thereof that forms a firing portion with a front end of the center electrode, so as to produce a spark discharge therebetween at the time of use. An air-fuel mixture is ignited in the firing portion.

In a direct injection engine, a fuel injected and sprayed from the injection orifice provided in a combustion chamber is mixed with air introduced through an inlet to thereby form an air-fuel mixture. Specifically, in a lean combustion operation mode, the injected fuel is not completely mixed with the air introduced in the combustion chamber, and an air-fuel mixture layer (herein referred to as a “combustible air-fuel mixture layer”), having a relatively high mixing ratio of the fuel to the air and easily ignitable, is formed. Then, the spark plug ignites the combustible air-fuel mixture layer at a time when the combustible air-fuel mixture layer that flows with an air current produced by a motion of piston or intake/exhaust operations in the combustion chamber, reaches the firing portion.

Since a time period when the combustible air-fuel mixture layer flowing with the air current in the combustion chamber is adrift around the firing portion (i.e., flowing in the vicinity of the firing portion) is limited, ignition to the air-fuel mixture tends to fail when the spark discharge is conducted before or after that time period. Thus, in the conventional engine, the timing of fuel injection or the ignition of a spark plug is controlled so as to securely ignite the combustible air-fuel mixture layer. For example, a timing (hereinafter referred to as an “ignition timing”) of spark discharge is accurately controlled so that the spark discharge is conducted when the combustible air-fuel mixture layer is adrift around the firing portion. Further, an amount of injecting fuel (injection time) is increased (extended) so that the combustible air-fuel mixture layer is adrift around the firing portion for a longer time period, whereby the ignition can be conducted when the ignition timing is slightly shifted. Alternatively, the spark discharge is conducted two or more times so as to overlap with the time period when the combustible air-fuel mixture layer is adrift around the firing portion.

However, without controlling the above described ignition timing or ignition technique, it is possible to control the combustible air-fuel mixture layer to be adrift around the firing portion by devising a spark plug structure. For example, the region surrounding the firing portion is covered with a wall surface (a protection member of the ground electrode) so that the combustible air-fuel mixture layer flowing around the circumference of the spark plug is introduced inside the circumference of the firing portion through a slit provided in the wall surface. See Japanese Patent Application Laid-Open (kokai) No. 2006-228522, hereinafter referred to as Patent Document 1. In this way, not only a central portion of the combustible air-fuel mixture layer having a high fuel ratio, but also an outer border portion of the combustible air-fuel mixture layer having a low fuel ratio, can be adrift around the spark plug whereby the ignitable combustible air-fuel mixture layer surrounds the circumference of the firing portion.

### SUMMARY OF THE INVENTION

However, since the conditions of fuel injection vary depending on engine operating conditions, it is difficult to accurately control an ignition timing to a combustible air-fuel mixture layer, and further, there is a problem that the cost for development is high because versatility is poor. When increasing an amount of fuel injection, fuel consumption deteriorates. Also, when the spark discharge is conducted two or more times, electrode erosion progresses, thereby shortening the service life of the spark plug. Further, according to Patent Document 1, unless a direction where the slit leads to and a direction where the combustible air-fuel mixture layer flows are consistent due to a state of the spark plug mounted on an engine head (i.e., deviation in the circumferential direction caused by a difference in screwing status), the following problem tends to arise. That is, the amount of combustible air-fuel mixture layer introduced inside the circumference of the firing portion decreases, and the ignitable combustible air-fuel mixture layer is unlikely to be adrift around the firing portion at the ignition timing.

The present invention has been accomplished in order to solve the above-mentioned problems, and an object of the present invention is to provide a spark plug capable of leading a combustible air-fuel mixture layer, which flows with an air current in a combustion chamber, inside a circumference of a firing portion so as to easily ignite the air-fuel mixture.

According to a first aspect of the present invention, there is provided a spark plug comprising: a center electrode; an insulator having an axial bore that extends in an axis direction and holding the center electrode at a front end side of the axial bore; a metal shell having a cylindrical hole that extends in the axis direction, and accommodating and holding the insulator in the cylindrical hole; and a ground electrode electrically connected to the metal shell and having one end thereof that forms a firing portion with a front end portion of the center electrode, wherein the metal shell includes at least three or more projecting portions at a front end face thereof which are formed intermittently in a circumferential direction so as to protrude towards the combustion chamber with respect to an inner wall surface of the combustion chamber when the spark plug is mounted on an engine head of an internal-combustion engine, and wherein, when the center of the firing portion and the projecting portions are projected on a plane perpendicular to the axis direction, formation positions of the projecting portions are disposed at an equal interval therebetween in the circumferential direction revolving around the center of the firing portion.

In the spark plug of the first aspect, when the projecting portions projecting from the front end face of the metal shell are viewed from the center of the firing portion, projecting portions are disposed at equal intervals therebetween in the circumferential direction whereby there is no bias. Thus, regardless of the mounting state of the spark plug, a side or an end of any one of the projecting portions can face at an upstream side in the flow direction of the combustible air-fuel mixture layer. Since the projecting portions are disposed in the circumferential direction, the combustible air-fuel mixture layer can be provided with a direction component directed to the firing portion as a reflective direction. That is, the combustible air-fuel mixture layer can be directed to the circumference of the firing portion. Notably, the combustible air-fuel mixture layer is provided with the direction component directed toward the firing portion, i.e., a direction vector perpendicular to the flow direction of the combustible air-fuel mixture layer before being reflected faces toward the firing portion. After being reflected, the direction vector of the combustible air-fuel mixture layer is subject to a vector resolution into a flow direction perpendicular to the flow direction before the reflection.

Depending on the mounting state of the spark plug, two projecting portions tend to serve as a pair and be disposed in parallel in a line in the flow direction of the combustible air-fuel mixture layer. In such a case, the combustible air-fuel mixture layer is intercepted by the projecting portion at an upstream side and cannot secure the flow direction colliding with the projecting portion at the downstream side that provides the direction component directed to the firing portion. On the other hand, since the spark plug according to the first aspect has at least three or more pieces of the projecting portions in an odd number, at least one or more projecting portions not located in a line in the flow direction can be obtained. Thus, the combustible air-fuel mixture layer can collide with the projecting portion and be provided with the direction component directed to the firing portion. In the spark plug according to the first aspect, although the projecting portions are disposed at an “equal interval” therebetween in the circumferential direction, tolerance due to a manufacturing process is included. Therefore, the intervals between the projecting portions may not be entirely equal. However, the present invention allows for this tolerance. The tolerance range is ±5% of the interval between the projecting portions. When a width between both ends of the projecting portion in the circumferential direction and a width between both ends of non-projecting portion in the circumferential direction are equal, the tolerance can be represented in a following relation.

[Tolerance]<={360 degrees/(2×n)}×0.10
(n: number of projecting portions)
   For example, when there are three pieces of projecting portions, the tolerance thereof may be allowed to be up to 6 degrees. The present invention can exhibit a sufficient effect in this tolerance range.

Further, in a spark plug according to a second aspect of the present invention, the ground electrode of the spark plug according to the first aspect is joined to a projecting front end of at least one of the plural projecting portions. A length t2 connecting both ends of the projecting front end in the circumferential direction is preferably longer than a length t1 connecting both ends of the ground electrode in the circumferential direction.

According to the configuration of the spark plug of the first aspect, the firing portion may be formed in the front end side of the center electrode, and the form of the spark plug is not particularly limited. In the spark plug having the ground electrode joined to the projecting front end of the projecting portion, as in the second aspect, the width of the ground electrode in the circumferential direction is preferably smaller than the width of the projecting portion. As long as the ground electrode forms the firing portion with the center electrodes, the ground electrode is disposed near the firing portion and is likely to intercept an inflow of the combustible air-fuel mixture layer to the firing portion. Thus, when the width of the ground electrode is made smaller than the width of the projecting portion as mentioned above, it is possible to prevent impeding inflow of the combustible air-fuel mixture layer due to the ground electrode.

Further, in a spark plug according to a third aspect of the present invention, the ground electrode of the second aspect preferably has one end in a longitudinal direction thereof joined to the projecting front end.

Furthermore, in a spark plug according to a fourth aspect of the present invention, when the center of the firing portion and the projecting portions are projected on a plane perpendicular to the axis direction of the spark plugs according to the first to third aspects, the firing portion is formed in an area including the axis of the metal shell, and a sum of angles where each angle is defined by straight lines connecting the center of the firing portion to both ends of an area that the projecting portion occupies in the circumferential direction, is preferably equal to a sum of angles where each angle is defined by straight lines connecting the center of the firing portion to both ends of an area that non-projecting portion occupies in the circumferential direction.

In this way, in the circumferential direction revolving around the center of the firing portion, the angle of the area where the projecting portion occupies and that of the area where the non-projecting portion occupies are the same. Thus, a sufficient interval can be provided between the adjacent projecting portions in the circumferential direction. Even when the projecting portions are disposed so as to intercept the combustible air-fuel mixture layer having the flow direction that passes around the firing portion, a sufficient amount of combustible air-fuel mixture layer can flow through the interval between the projecting portions. The combustible air-fuel mixture layer flowing through the non-projecting portion may have a flow direction which collides with the other projecting portion disposed at the downstream side of the flow direction. The thus-reflected combustible air-fuel mixture layer can be adrift around the firing portion. In the spark plug according to the fourth aspect, although it is mentioned above that the angle defined by straight lines connecting the center of the firing portion to both ends of an area that the projecting portion occupies is equal to the angle defined by straight lines connecting the center of the firing portion to both ends of an area that non-projecting portion occupies, a tolerance caused by a manufacturing process may be included. Therefore, the above-mentioned angles may not be entirely equal, however, the present invention allows for this tolerance. The difference between the angle of the area where the projecting portion occupies and that of the area where the non-projecting portion occupies is up to 10%. The tolerance can be represented in the following relation.

[Tolerance]<={360 degrees/(2×n)}×0.10
(n: number of projecting portions)
   For example, when there are three pieces of projecting portions, the difference between the angle of the area where the projecting portion occupies and that of the area where the non-projecting portion occupies may be allowed to be up to 6 degrees. The present invention can exhibit a sufficient effect in this tolerance range.

### BRIEF DESCRIPTION OF THE DRAWINGS

FIG. 1 is a partially sectional view of a spark plug 100 mounted on an engine head 200 of an internal-combustion engine.

FIG. 2 is a sectional view of the spark plug 100 seen from an arrow direction at line Z-Z, which intersects perpendicular to an axis O through a center S of a firing portion 70 in FIG. 1.

FIG. 3 is a schematic showing a simulation model (sample 1) of the spark plug that has three pieces of projecting portions or the like and projected in a virtual plane perpendicular to the axis O.

FIG. 4 is a schematic showing a simulation model (sample 2) of the spark plug that has five pieces of projecting portions or the like and projected on the virtual plane perpendicular to the axis O.

FIG. 5 is a schematic showing a simulation model (sample 3) of the spark plug that has seven pieces of projecting portions or the like and projected on the virtual plane perpendicular to the axis O.

FIG. 6 is a partially sectional view of the spark plug 100 mounted on an engine head 400 of an internal-combustion engine.

### DETAILED DESCRIPTION OF THE INVENTION

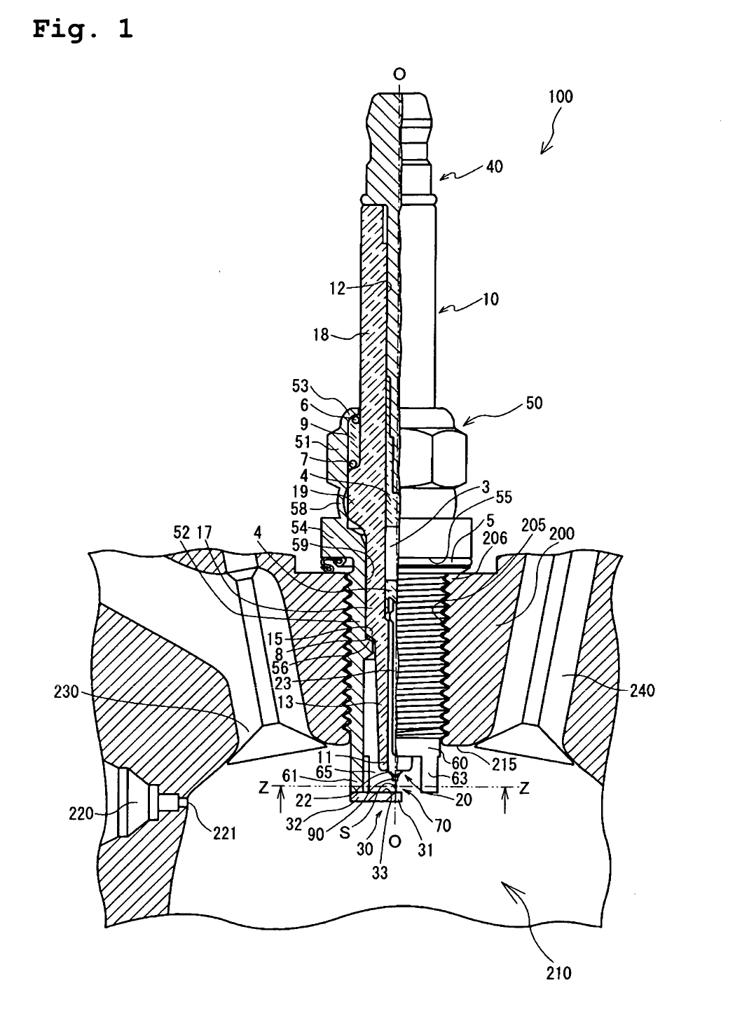

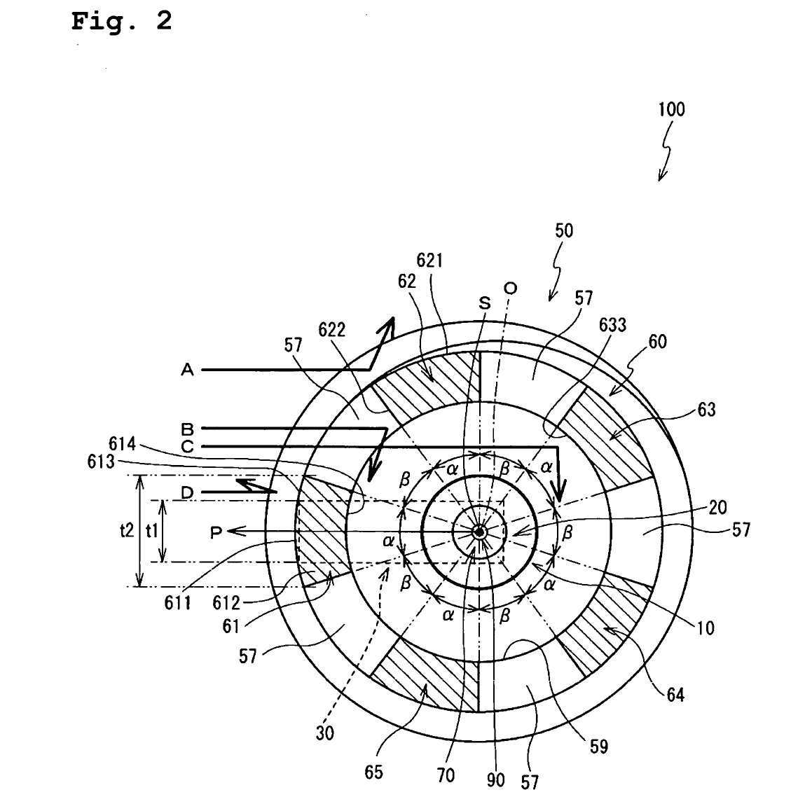

Hereafter, a first embodiment of a spark plug carrying out the present invention will be described with reference to the drawings. First, with reference to FIGS. 1 and 2, a configuration of a spark plug 100 will be described as one of the embodiments. In FIG. 1, a direction of an axis “O” of the spark plug 100 is regarded as the top-to-bottom direction in the drawing. A lower side of the drawing is regarded as a front end side of the spark plug 100 and an upper side of the drawing is regarded as a rear end side of the spark plug 100.

As shown in FIG. 1, the spark plug 100 according to the first embodiment is mounted on an engine head 200 of a so-called direct injection-type engine that directly injects a fuel into a combustion chamber 210. In the combustion chamber 210, the fuel injected from an injector orifice 221 of an injector 220 is mixed with air introduced from an intake port 230 and flows with an air current produced by motion of piston (not illustrated) in the combustion chamber 210. Thereafter, the fuel flows around a firing portion 70 of the spark plug 100, and is ignited by spark discharge in the firing portion 70.

As shown in FIG. 1, the spark plug 100 is generally comprised of an insulator 10, a metal shell 50, a center electrode 20, a ground electrode 30 and a metal terminal fitting 40. The metal shell 50 holds the insulator 10 therein. The center electrode 20 extends in the axis “O” direction and is accommodated in an axial bore 12 of the insulator 10. The ground electrode 30 has a base end portion 32 welded to a front end side of the metal shell 50 and a front end portion 31 having an inner face 33 that produces a spark discharge with a noble metal tip 90 formed on a front end of the center electrode 20. The metal terminal fitting 40 is provided at a rear end portion of the insulator 10.

First, the insulator 10 constituting an insulator of the spark plug 100 will be explained. The cylindrical insulator 10 is made of sintered alumina or the like as is commonly known and includes the axial bore 12 extending along the axis “O”. A flange portion 19, having the largest outer diameter, is formed on the rear end side with respect to a central area in the axis “O”. A rear end side body portion 18 is formed on the rear end side (upper side in FIG. 1) with respect to the flange portion 19. A front end side body portion 17 having an outer diameter smaller than that of the rear end side body portion 18 is formed on the front end side (lower side in FIG. 1) with respect to the flange portion 19. Further, an elongated leg portion 13 having an outer diameter smaller than that of the front end side body portion 17 is formed on the front end side with respect to the front end side body portion 17. The diameter of the elongated leg portion 13 is gradually tapered towards the front end side. The elongated leg portion 13 is exposed to a combustion chamber when the spark plug 100 is mounted on an engine head 200 of an internal combustion engine.

Next, the center electrode 20 will be described. The center electrode 20 is made of nickel-system alloys or the like such as INCONEL (trade name) 600 or 601 in which a metal core 23 comprised of copper or the like with excellent thermal conductivity is provided. The center electrode 20 is held in the front end side of the axial bore 12 of the insulator 10 so that an axis of the center electrode 20 is coaxially-arranged with the axis O of the spark plug 100. A front end portion 22 of the center electrode 20 projects from a front end portion 11 of the insulator 10, and such projecting portion is tapered towards the front end side. A noble metal tip 90 for improving resistance to spark erosion is welded to a front end of the projecting portion.

Further, the center electrode 20 is electrically connected to the metal terminal fitting 40 on the rear end side through a seal material 4 and a ceramic resistance 3, both provided inside the axial bore 12. A high-tension cable (not shown) is connected to the metal terminal fitting 40 through a plug cap (not shown) where high voltage is applied.

Next, the metal shell 50 will be described. The metal shell 50 is a cylindrical metal fitting for fixing the spark plug 100 to the engine head 200 of the internal-combustion engine. The metal shell 50 has a cylindrical hole 59 which accommodates the insulator 10 therein so as to surround a region from the elongated leg portion 13 to a front end side of the rear end side body portion 18 of the insulator 10. The metal shell 50 is made of a low carbon steel material and has a large diameter fitting portion 52 formed in a region from a generally center to the front end side of the metal shell. On an outer circumference face of the fitting portion 52, a male-thread-shaped thread ridge is formed for engaging with a female thread provided on a mounting hole 205 of the engine head 200 whereby the spark plug 100 is fixed in the mounting hole 205. In addition, the metal shell 50 may be made of stainless steel or INCONEL and the like, placing great importance on heat resistance.

A flange-like sealing portion 54 is formed on the rear end side of the fitting portion 52. A gasket 5, which is made from a sheet material and formed into an annular shape, is provided between the sealing portion 54 and the fitting portion 52. The gasket 5 provides a seal for air leakage from the combustion chamber 210 through the mounting hole 205. More particularly, the gasket 5 is sandwiched and deformed between a seating face 55 of the sealing portion 54, which faces the front end side, and an opening edge portion 206 of the mounting hole 205 of the engine head 200, to provide a seal therebetween.

Further, a tool engagement portion 51 for engaging with a spark plug wrench (not illustrated) is formed on the rear end side of the sealing portion 54. A thin caulking portion 53 is formed on the rear end side with respect to the tool engagement portion 51. A thin buckling portion 58 is formed between the sealing portion 54 and the tool engagement portion 51. Annular ring members 6, 7 lie between an inner circumferential face of the cylindrical hole 59, where the tool engagement portion 51 and the caulking portion 53 are formed, and an outer circumferential face of the rear end side body portion 18 of the insulator 10. Furthermore, talc powder 9 is filled between the both ring members 6, 7. On the inner circumferential face of the cylindrical hole 59, an inwardly projecting step portion 56 is formed in a continuous manner along the circumference direction. When the insulator 10 is accommodated in the cylindrical hole 59, a step portion 15 of the insulator 10, formed between the elongated leg portion 13 and the front end side body portion 17 of the insulator 10, is supported by the step portion 56 through an annular plate packing 8. Then, the edge portion of the caulking portion 53 is caulked and inwardly bent so that the insulator 10 is compressed towards the front end side in the cylindrical hole 59 through the ring members 6,7 and the talc 9. At this time, the buckling portion 58 is heated so as to outwardly deform under an application of compressive force in a caulking process. As a result, the caulking portion 53 can provide some room for compression stroke. In this way, the insulator 10 is securely held between the caulking portion 53 and the step portion 56 in the cylindrical hole 59 whereby the metal shell 50 and the insulator 10 is integrated. The packing 8 secures the airtightness between the metal shell 50 and the insulator 10, thereby preventing combustion gas from flowing out through the cylindrical hole 59.

Moreover, on the front end side with respect to the fitting portion 52, a cylinder-shaped cylindrical portion 60 extending forward along the axis O direction is formed. Further, five projecting portions 61-65 are formed in a front end face 57 of the cylindrical portion 60 (only three projecting portions 61, 63 and 65 are shown in FIG. 1).

Next, the projecting portions 61-65 of the metal shell 50 will be described in detail. The projecting portions 61-65 are formed in such a manner that the front end face 57 of the annular-shaped cylindrical portion 60 is equally divided into generally ten pieces in a circumferential direction and every other thus-formed fan shape portion is extended with an equal length in the axis O direction, respectively. As shown in FIG. 2, the projecting portions 61-65 assume a fan shape in a cross-section perpendicular to the axis O (i.e., a remaining shape where a small diameter fan-shaped portion having an equal opening angle to a large diameter fan-shaped portion is removed (cut) from the large diameter fan-shaped portion). That is, the projecting portions 61-65 assume the generally same shape in the cross-section taken from a plane X (in FIG. 2) that is perpendicular to the axis O and passes through a center S of the firing portion 70.

Generally, the noble metal tip 90 is joined to the front end portion 22 of the center electrode 20 so that the axis O serves as a central axis. For convenience, a middle of a gap between the front end face of the noble metal tip 90 and the inner face 33 of the ground electrode 30 on the axis O serves as the center S of the firing portion 70 in this embodiment. Front end faces 57 of the cylindrical portion 60 disposed between the projecting portions 61-65 also assume a fan-shape, which is generally the same shape as the cross-section of the projecting portions 61-65. That is, the cross-sectional positions of projecting portions 61-65 in the plane X (i.e. the formation position of each projecting portion 61-65) are disposed at a generally equal interval therebetween when viewing from the center S of the firing portion 70. More particularly, when viewing a radial direction from the center S of the firing portion 70, each angle α defined by the straight lines which connects the center of the firing portion to both ends of an area where the projecting portion 61-65 occupies in the circumferential direction (i.e., a cross-sectional position taken from the plane X), is almost the same. The angle defined by the two straight lines which connects the center of the firing portion to both ends of the area where the projecting portion occupies in the circumferential direction, means an angle opposed to the projecting portion among the angles defined by the straight lines. Similarly, each angle β defined by two straight lines which connects the center of the firing portion to both ends of an area where the non-projecting portion is formed in the circumferential direction (i.e., a position of the front end face 57 projected on the plane X), is almost the same. Therefore, the sum of the angles α of the area where projecting portions 61-65 occupy in the circumferential direction, and the sum of the angles β of the area where non-projecting portions occupy in the circumferential direction, are also almost the same.

The ground electrode 30 is joined to a projecting front end 612 of the projecting portion 61 among the projecting portions 61-65 so as to form the firing portion 70 where the spark discharge is produced with the noble metal tip 90 joined to the center electrode 20. The ground electrode 30 is comprised of a metal having an excellent corrosion resistance. As one of the examples, a nickel alloy, such as INCONEL (trade name) 600 or 601, is used. The ground electrode 30 assumes a generally rectangular shape as seen from the cross-section in the longitudinal direction. The base end portion 32 of the ground electrode 30 is welded to the projecting front end 612 of the projecting portion 61 of the metal shell 50. The front end portion 31 of the ground electrode 30 extends towards the axis “O” so that the inner face 33 faces the front end portion 22 of the center electrode 20. Further, the firing portion 70 (i.e., spark discharge gap) is formed between the inner face 33 and the noble metal tip 90 joined to the front end portion 22 of the center electrode 20. Furthermore, as shown in FIG. 2, the projecting portion 61 joined to the ground electrode 30 has a length t2 that connects both ends of the projecting portion in the circumferential direction revolving around the firing portion 70 (referred to as a width direction). Length t2 is longer than a length t1 (a length that connects both ends of the ground electrode 30 at outer circumference side in the circumferential direction) of the ground electrode 30 in the width direction.

The spark plug 100 having such shape of the projecting portions 61-65 is mounted on the engine head 200 shown in FIG. 1. When the spark plug 100 is mounted on the mounting hole 205 of the engine head 200, the projecting portions 61-65 project towards inner side of the combustion chamber 210 with respect to an inner wall surface 215 of the combustion chamber 210. That is, when the spark plug 100 is mounted on the mounting hole 205 of the engine head 200, the projecting portions 61-65 are exposed to the combustion chamber 210. Here, the inner wall surface 215 of the combustion chamber 210 means an inner surface among the wall surfaces which define the inside and the outside of the combustion chamber 210. When an engine is in operation, the spark plug 100 is exposed to an air-fuel mixture which is comprised of the fuel injected from the injection orifice 221 of the injector 220 and an air introduced from the intake port 230 to the combustion chamber 210. When the combustible air-fuel mixture layer passes around the firing portion 70 of the spark plug 100, a portion of the combustible air-fuel mixture layer collides with the projecting portions 61-65 exposed in the combustion chamber 210. Then, a portion of the combustible air-fuel mixture layer which collides with a side face (i.e., an inner circumference face and an outer circumference face of the fan as viewed in the cross-section) or an end face (i.e., both sides of the fan in the circumference direction as viewed in the cross-section) of the projecting portions 61-65 is reflected whereby a flow direction of the combustible air-fuel mixture layer is altered. When this reflected combustible air-fuel mixture layer has a direction component directed toward the firing portion 70 as a reflective direction, the reflected combustible air-fuel mixture layer can flow around (i.e., flow in the vicinity of) the firing portion 70.

For example, as viewing from the center S of the firing portion 70 in FIG. 2, when the injection orifice 221 (refer to FIG. 1) is disposed on the projecting portion 61 side to which the ground electrode 30 is joined, the combustible air-fuel mixture layer flows from left to right. Here, a direction from the center S of the firing portion 70 to a center of an opening (not illustrated) of the injection orifice 221 is referred to as “P”.

The combustible air-fuel mixture layer which flows along an arrow “A” collides with an outer circumference side face 621 of the projecting portion 62, which inclines at least at 54 degrees or more with respect to the direction P viewing from the center S of the firing portion 70. Thus, the flow direction of the combustible air-fuel mixture layer is altered to a direction including the direction component directed away from the firing portion 70, and the combustible air-fuel mixture layer does not approach the inner circumference side of the cylindrical hole 59. The combustible air-fuel mixture layer flowing along an arrow “B” collides with an end face 622 of the projecting portion 62 on the injection orifice 221 side. Thus, the flow direction of the combustible air-fuel mixture layer is altered to a direction including the direction component directed to the firing portion 70, and the combustible air-fuel mixture layer approaches the inner circumference side of the cylindrical hole 59. The combustible air-fuel mixture layer flowing along an arrow “C” collides with an inner circumference side face 633 of the projecting portion 63 which inclines at least at 126 degrees or more with respect to the direction P viewing from the center S of the firing portion 70. Thus, the flow direction of the combustible air-fuel mixture layer is altered to a direction including the direction component directed to the firing portion 70, and the combustible air-fuel mixture layer approaches the inner circumference side of the cylindrical hole 59. The combustible air-fuel mixture layer flowing along an arrow D collides with an outer circumference side face 611 of the projecting portion 61 on the injection orifice 221 side viewing from the center S of the firing portion 70. Thus, a flow direction of the combustible air-fuel mixture layer is altered to a direction including the direction component directed away from the firing portion 70, and the combustible air-fuel mixture layer does not approach the inner circumference side of the cylindrical hole 59.

When the projecting portions 62 and 63 are not formed, the combustible air-fuel mixture layer flowing along the arrows A, B and C pass to the side of the firing portion 70. However, the combustible air-fuel mixture layer flowing along the arrows B and C can be provided with the direction component directed to the inner circumference side of the cylindrical hole 59 by forming the projecting portions 62, 63. That is, when the combustible air-fuel mixture layer flowing with the air in the combustion chamber 210 passes to the side of the firing portion 70, the flow direction of the combustible air-fuel mixture layer can be altered towards the circumference of the firing portion 70. When a positional relation between the center S of the firing portion 70, the projecting portion 61 and the injection orifice 221 (refer to FIG. 1) is as in FIG. 2, the projecting portions 62, 63 are disposed symmetrically to the projecting portions 65, 64 with respect to the direction P. Thus, the same above-mentioned phenomenon is applied to the combustible air-fuel mixture layer passing along the side of the projecting portions 64 and 65 viewing from the center S of the firing portion 70.

In this embodiment, as described above, when viewing the projecting portions 61-65 from the center S of the firing portion 70 in the radial direction, the projecting portions 61-65 assume generally the same shape and are disposed at a generally equal interval therebetween. Therefore, there is no bias in the circumferential direction of the axis O. Even though the projecting portions 61-65 are shifted in the circumferential direction due to a mounting state of the spark plug 100, the side face or the end face of any one of the projecting portions 61-65 can provide the combustible air-fuel mixture layer with the direction component directed to the circumference of the firing portion 70 as a reflective direction.

The projecting portions 61-65 and non-projecting portions are alternatively formed at a generally equal angle, occupying equal area in a sequential manner. That is, there is a sufficient interval between the adjacent projecting portions 61-65 in the circumferential direction. Even though the projecting portion is disposed upstream of the flow direction of the combustible air-fuel mixture layer with respect to the center S of the firing portion 70 so as to intercept the combustible air-fuel mixture layer flowing through the circumference of the firing portion 70, only a portion of the combustible air-fuel mixture layer is intercepted. The combustible air-fuel mixture layer that is not intercepted can flow through the circumference of the firing portion 70. Further, when the combustible air-fuel mixture layer collides with the projecting portion disposed downstream of the combustible air-fuel mixture layer with respect to the center S of the firing portion 70, the combustible air-fuel mixture layer is reflected and can be adrift around the firing portion 70.

Thus, in order for the combustible air-fuel mixture layer colliding with the projecting portions to flow towards the firing portion regardless of the mounting status of the spark plug, the number of the projecting portions is preferably at least three or more in odd numbers. When the number of the projecting portions is even numbers, two projecting portions serve as a pair and tend to be disposed in a line in the flow direction of the combustible air-fuel mixture layer. In this case, the combustible air-fuel mixture layer colliding with the projecting portions at the downstream is intercepted by the projecting portions at the upstream. Further, the combustible air-fuel mixture layer collides with the side face of the outer circumference of the projecting portions at the upstream and flows away from the firing portion. Furthermore, the combustible air-fuel mixture layer not colliding with the projecting portions at the upstream just passes through the circumference of the firing portion, because it does not collide with the projecting portions at the downstream. When the number of projecting portions is odd numbers, at least one or more projecting portion(s) which is/are not disposed in a line in the flow direction may be provided in any circumstance.

Further, the width t1 (the length between both ends of the ground electrode 30 in the circumferential direction revolving around the firing portion 70) of the ground electrode 30 is smaller than the width t2 of the projecting portion 61. Therefore, although the ground electrode 30 of this embodiment is disposed in the circumference of the firing portion 70 along with the projecting portions 61-65, the ground electrode 30 is unlikely to intercept the flow of the combustible air-fuel mixture layer. As in the spark plug 100, when the length of the outer circumference face 613 of the projecting portion 61 in the circumferential direction differs from that of an inner circumference face 614 of the projecting portion 61 in the circumferential direction, a width in the circumference direction which influences the flow of the combustible air-fuel mixture layer should be the width t2.

### EMBODIMENT 1

A simulation was conducted in order to confirm whether or not a sufficient amount of combustible air-fuel mixture layer flows toward the firing portion 70, regardless of the mounting status of the spark plug 100 on the engine head 200, when the number of the projecting portions is at least three or more pieces in odd numbers as mentioned above. In this simulation, simulation samples of the spark plug (samples 1, 2 and 3) having three, five or seven pieces of projecting portions, respectively, were prepared. The projecting portions were formed in the samples at an equal interval therebetween in the circumferential direction. In each sample, the sum of angles of the projecting portions was equal to the sum of angles of the non-projecting portions, as viewed from the center S of the firing portion.

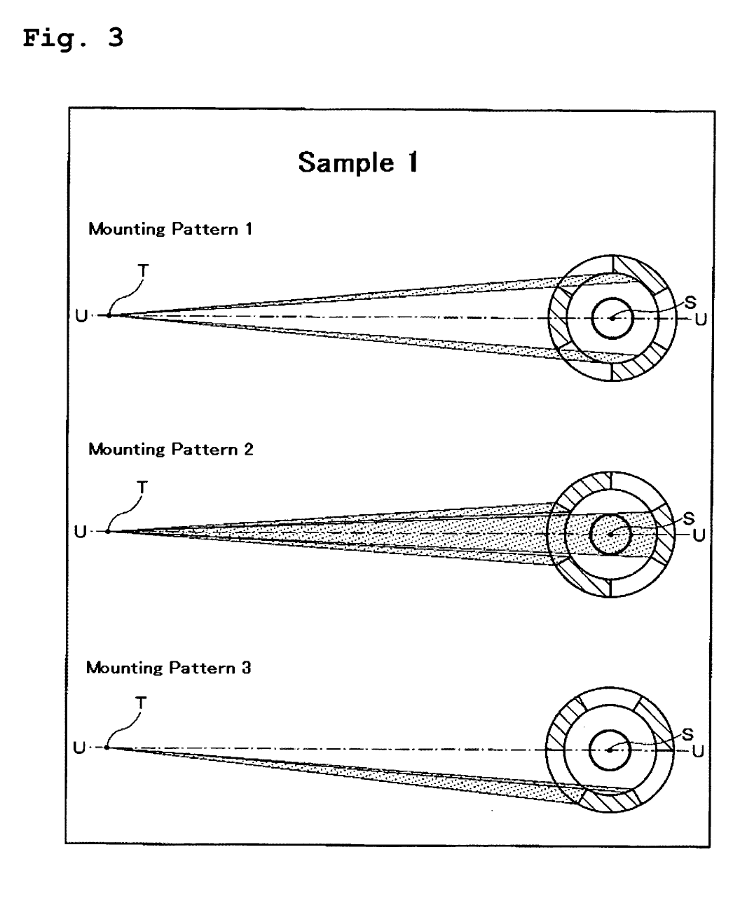

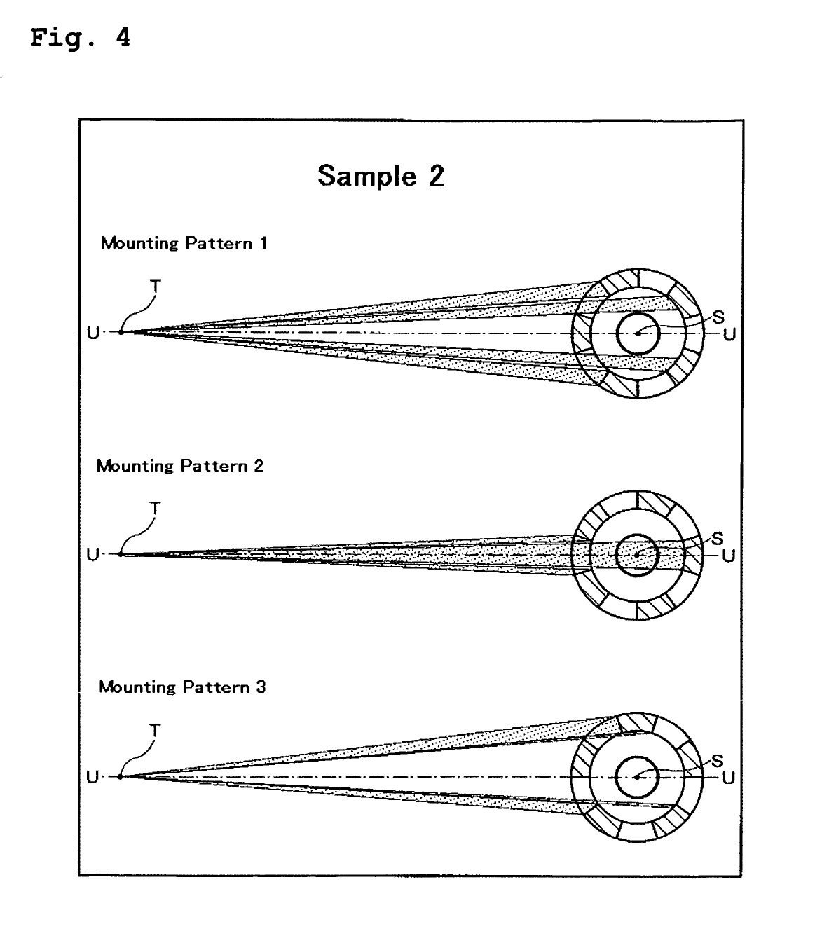

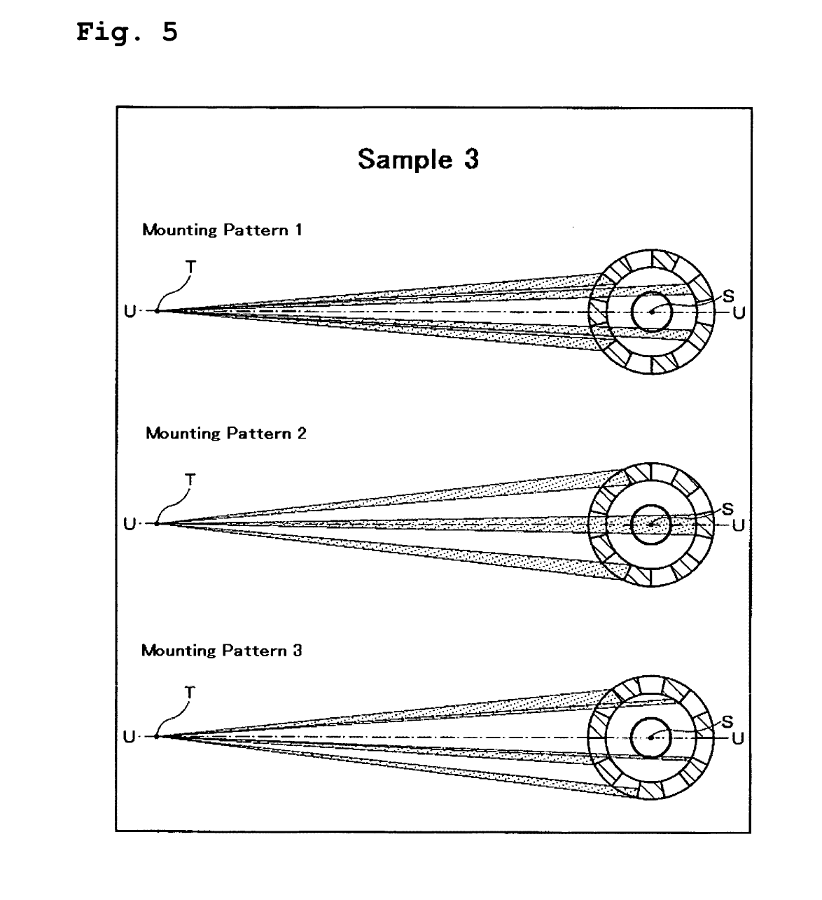

The result of the simulation using each sample is shown in FIGS. 3-5. In FIGS. 3-5, the projecting portions and the center S of the firing portion of each sample are projected on a virtual plane perpendicular to the axis O, and also the injection orifice is projected thereon at a position corresponding to a positional relation between the spark plug and the injection orifice of the injector in the combustion chamber. An opening center of the injection orifice is expressed as “T”.

As a mounting pattern 1, one of the projecting portions of each sample is disposed between the opening center T and the center S of the firing portion on a virtual straight line “U” which connects the opening center T to the center S of the firing portion, and the flow direction of the fuel (the combustible air-fuel mixture layer) injected from the opening center T was simulated. In FIGS. 3 to 5, a hatching pattern with dots shows a possible reflective direction range after the fuel collided with the projecting portions, which includes the direction component directed to the center S of the firing portion. In FIGS. 3 to 5, the slash-like hatching pattern shows the positions of the projecting portions. Similarly, as a mounting pattern 2, each projecting portion of the mounting pattern 1 was rotated at 180 degrees revolving around the center S of the firing portion. In FIGS. 3 to 5, a hatching pattern with dots shows a possible reflective direction range after the fuel collided with the projecting portions, which includes the component direction directed to the center S of the firing portion in the flow direction of the fuel (the combustible air-fuel mixture layer) injected from the opening center T. As a mounting pattern 3, the position of each projecting portion was rotated around the center S of the firing portion so that an end face of the arbitrarily selected projecting portion aligns with the virtual straight line U. In FIGS. 3 to 5, a hatching pattern with dots shows a possible reflective direction range after the fuel collided with the projecting portion, which includes the direction component directed to the center S of the firing portion in the flow direction of the fuel (the combustible air-fuel mixture layer) injected from the opening center T.

As shown in FIGS. 3 to 5, in any samples of the mounting pattern 1, the combustible air-fuel mixture layer with the flow direction to the center S of the firing portion from the opening center T was intercepted by the side face of the outer circumference of the projecting portion whereby the combustible air-fuel mixture layer could not reach to the center S of the firing portion. However, the combustible air-fuel mixture layer with the flow direction flowing outward in the circumferential direction with respect to the end faces of the projecting portion collided with end faces or side faces of the inner circumference of other projecting portions, which were adjacent to the projecting portion in the circumferential direction. Thus, the direction component directed to the firing portion can be provided. Next, in any samples of the mounting pattern 2, the combustible air-fuel mixture layer with the flow direction to the center S of the firing portion from the opening center T went through and around the center S of the firing portion, and flowed at the downstream in the flow direction. However, since the combustible air-fuel mixture layer at the downstream collided with the side face of the inner circumference of the projecting portion that was disposed at the downstream in the flow direction, the combustible air-fuel mixture layer could be provided with the direction component directed to the firing portion. In any sample of the mounting pattern 3, a pair of projecting portions in the plural projecting portions was disposed in alignment with the virtual straight line U. However, at least one of the projecting portions was not aligned with the virtual straight line U.

The present invention may be changed or modified in various ways. In the above embodiment, the projecting portions 61-65 are formed in such a manner that the front end face 57 of the annular cylindrical portion 60 is divided into generally ten pieces in the circumferential direction, and the thus-divided pieces are alternately extended and formed into a fan-shape in the cross-section. However, the projecting portion does not necessarily assume the fan-shape in the cross-section. For example, the projecting portion may assume a rectangular, circular, trapezoidal or polygonal shape in the cross-sectioned view. When the cross section of the projecting portion does not assume the fan-shape, the sum of angles where the projecting portions occupy in the circumferential direction is preferably generally equal to the sum of angles where non-projecting portions occupy in the circumferential direction. In this way, a sufficient interval is secured between the adjacent projecting portions in the circumferential direction, and the combustible air-fuel mixture layer can be adrift around the firing portion regardless of the mounting state of the spark plug. When the cross-section of the projecting portion does not assume the fan-shape, the angle where the non-projecting portion occupies in the circumferential direction is preferably determined based on a middle point between an end portion of the outer circumference side of the projecting portion and an end portion of the inner circumference side of the projecting portion. This base point provides an adequate angle where the projecting portion is formed.

Moreover, the projecting portion does not necessarily assume a columnar-shape in the cross-section, but may assume a tapered-shape that tapers off towards the front end side or a shape where the front end side of the projecting portion becomes gradually thicker. The sectional shape of the projecting portion is not necessarily constant. However, in order to reflect the combustible air-fuel mixture layer that collided with the projecting portions 61-65 and provide the direction component directed to the firing portion, the projecting portion preferably has a concave side face in its inner circumference which is bent in the circumferential direction.

In the embodiment, although the ground electrode 30 is joined to the projecting front end 612 of the projecting portion 61, it may be joined to a projecting end of other projecting portions 62-65 (not illustrated). The number of ground electrodes is also not limited to one. The ground electrode 30 may be integrally formed with the projecting portion 61, and a portion serving as the ground electrode 30 may be bent so as to face the front end portion 22 of the center electrode 20. Further, the cylindrical portion 60 and the projecting portions 61-65 may be formed into separate bodies, and the projecting portions 61-65 may be joined to the front end face 57 of the cylindrical portion 60, respectively. Alternatively, a crown-like body may be produced in such a manner that a cylindrical metal tube is cut into a shape where the projecting portions 61-65 project from the cylindrical portion 60, and the-thus crown like body may be joined to the front end of the metal shell 50.

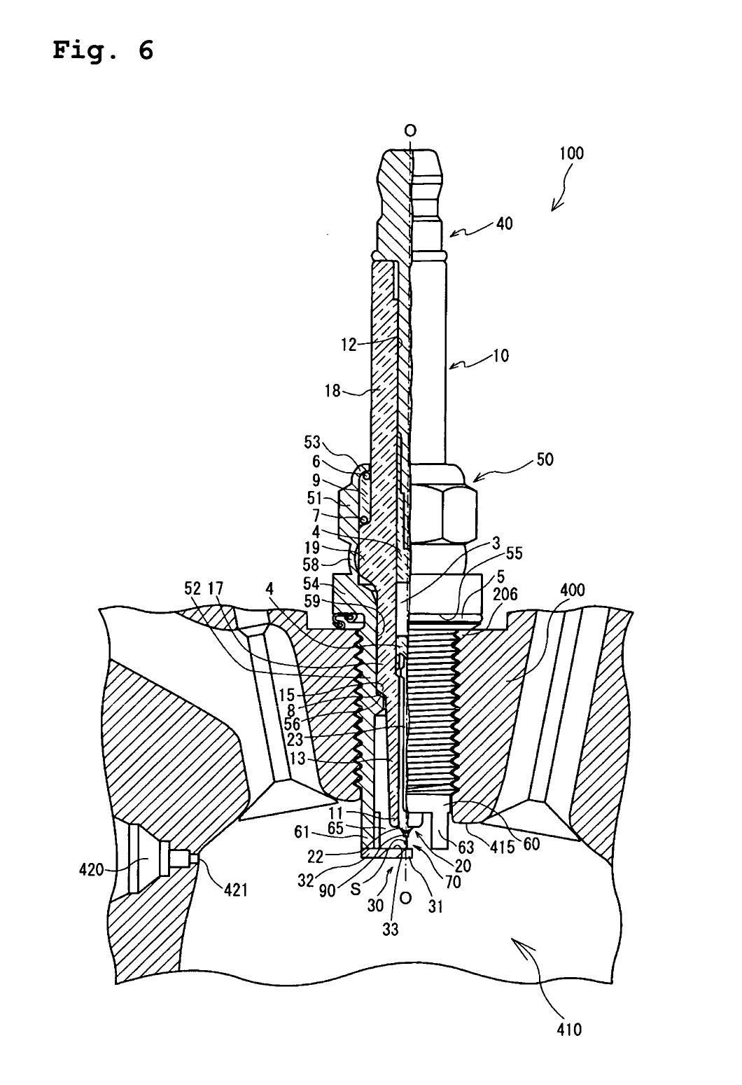

Each projecting portion provided in odd numbers does not necessarily have the same amount of projection length. For example, the side face (lower face side in FIGS. 1 and 6) at the front end side of the ground electrode and the front end face of the projecting portion may be located in the same position in the axis direction. For example, the front end face of the projecting portion may be located on the front end side in the axis direction with respect to the side face of the ground electrode on the combustion chamber side.

In the state where the spark plug 100 is mounted on the engine head of the internal-combustion engine, at least the front end portions of the projecting portions 61-65 (refer to FIG. 2) may protrude towards the combustion chamber side with respect to the inner wall surface of the combustion chamber. For example, as shown in FIG. 6, in the state where the spark plug 100 is mounted on an engine head 400 of the internal-combustion engine, the front end portion of the projecting portion 61-65 (refer to FIG. 2) protrudes towards a combustion chamber 410 side with respect to an inner wall surface 415 of the combustion chamber 410. On the other hand, the portion where the non-projecting portion is formed (the cylindrical portion 60) does not protrude towards the combustion chamber 410 side with respect to the inner wall surface 415. In such a state, the fuel injected from an injection orifice 421 of an injector 420 also forms a combustible air-fuel mixture layer. A portion of the combustible air-fuel mixture layer collides with the projecting portions and goes to the firing portion. In this way, the present invention brings about the desired effect.

1. A spark plug comprising:
a center electrode;
an insulator having an axial bore that extends in an axis (O) direction and holding the center electrode at a front end side of the axial bore;
a metal shell having a cylindrical hole that extends in the axis (O) direction, and accommodating and holding the insulator in the cylindrical hole; and
a ground electrode electrically connected to the metal shell and having one end thereof that forms a firing portion with a front end portion of the center electrode,
wherein the metal shell includes at least three or more projecting portions at a front end face thereof which are formed intermittently in a circumferential direction so as to protrude towards the combustion chamber with respect to an inner wall surface of the combustion chamber when the spark plug is mounted on an engine head of an internal-combustion engine, and
wherein, when a center of the firing portion and the projecting portions are projected on a plane perpendicular to the axis (O) direction, formation positions of the projecting portions are disposed at an equal interval therebetween in the circumferential direction revolving around the center of the firing portion.

2. A spark plug according to claim 1,
wherein the ground electrode is joined to a projecting front end of at least one of the plural projecting portions, and
wherein a length t2 connecting both ends of the projecting front end in the circumferential direction is longer than a length t1 connecting both ends of the ground electrode in the circumferential direction.

3. A spark plug according to claim 2,
wherein the ground electrode has one end in a longitudinal direction thereof joined to the projecting front end.

4. A spark plug according to claim 1, wherein, when the center of the firing portion and the projecting portions are projected on a plane perpendicular to the axis (O) direction, the firing portion is formed in an area including the axis of the metal shell, and a sum of angles (α) where each angle (α) is defined by straight lines connecting the center of the firing portion to both ends of an area that the projecting portion occupies in the circumferential direction, is equal to a sum of angles (β) where each angle (β) is defined by straight lines connecting the center of the firing portion to both ends of an area that non-projecting portion occupies in the circumferential direction.
